(19) United States
(12) Patent Application Publication
(10) Pub. No.: US 2011/0023333 A1
(43) Pub. Date: Feb. 3, 2011

(54) Composite Materials Composed Of An Elastic Polyurethane Molding And Rubber With Improved Adhesion

(76) Inventors: Markus Schutte, Osnabruck (DE); Udo Wendel, Kumhausen (DE); Bernd Bruchmann, Freinsheim (DE); Daniel Schonfelder, Mannheim (DE); Sibylle Schops, Munster (DE); Nils Mohmeyer, Osnabruck (DE)

Correspondence Address: HOWARD & HOWARD ATTORNEYS PLLC;BASF SE, 450 West Fourth Street, Royal Oak, MI, 48067, US

(21) Appl. No.: 12/443,152

(22) PCT Filed: Sep. 17, 2007
(86) PCT No.: PCT/EP2007/059799

§ 371 Date: Mar. 22, 2010

(30) Foreign Application Priority Data
Sep. 29, 2006 (EP) EP 06121514.1
Sep. 17, 2007 (EP) PCT/EP2007/059799

(51) Int. Cl. A43B 13/22; B32B 27/40; B32B 3/26

(52) U.S. Cl. 36/32 R; 428/423.1; 428/424.8; 521/137; 428/423.7

(57) ABSTRACT

The present invention relates to a composite comprising an elastic polyurethane molding with compact surface and with cellular core and rubber, capable of production via introduction of a reaction mixture, obtainable via mixing of (a) organic polyisocyanates with (b) at least one compound having at least two reactive hydrogen atoms, (c) chain extenders and/or crosslinking agents, (d) blowing agents, (e) catalysts, (f) hyperbranched polymers, and (g) if appropriate, other auxiliaries and/or additives, into a mold, comprising rubber, and also to a process for production of these composite materials, and to the use of these composite materials as shoe soles.

The present invention relates to a composite material comprising an elastic polyurethane molding with compact surface and with cellular core and rubber, capable of production via introduction of a reaction mixture, obtainable via mixing of (a) organic polyisocyanates with (b) at least one compound having at least two reactive hydrogen atoms, (c) chain extenders and/or crosslinking agents, (d) blowing agents, (e) catalysts, (f) hyperbranched polymers, and (g) if appropriate, other auxiliaries and/or additives, into a mold, comprising rubber, and also to a process for production of these composite materials, and to the use of these composite materials as shoe soles.

Further embodiments of the present invention can be found in the claims, in the description, and in the examples. The abovementioned features of the inventive subject matter and its features which will be explained below can, of course, be used not only in the particular stated combination but also in other combinations, without exceeding the scope of the invention.

Elastic polyurethane moldings with compact surface and with cellular core, known as integral flexible polyurethane foams, have been known for a long time, and are used in various sectors. A typical use is the use as shoe sole, for example for outdoor shoes, sports shoes, sandals, and boots.

An example of another traditional sole material currently used alongside elastic polyurethane moldings is rubber. There are long-established methods for processing rubber, and shoe soles with excellent mechanical properties can be produced. One particular advantage of rubber soles is their excellent slip resistance, in particular on moist substrates. One disadvantage of rubber soles in comparison with elastic polyurethane moldings is higher density, and it is that these shoe soles are therefore heavier.

Shoe soles with rubber as outer sole and with an elastic polyurethane molding as midsole have been produced for some years, the term used for this being “combisole”. The result is a combination of the good mechanical properties of rubber, e.g. excellent slip resistance and no abrasion, with the advantages of the elastic polyurethane molding, e.g. low density, high elasticity, and good damping properties. There are two alternatives for the production process. In a first process, polyurethane is injection-molded directly onto the rubber outer sole to bond this to the shoe upper. In this process, the polyurethane reaction mixture is charged to a mold which comprises an outer sole composed of rubber, and which is sealed via the shoe upper. In a second process, the polyurethane mixture is cast over a rubber element which has been placed, as outsole or as appliqué or portion of the outsole, in a conventional sole casting mold for molded polyurethane soles. The resultant “combisole” is adhesive-bonded to the shoe or adhesive bonded/sown in a combined process.

“Combisoles” need a high level of adhesion between the outsole and midsole, in order to prevent subsequent failure of the material due to delamination of the sole. Adhesion between the outsole and midsole is determined via peel tests. In practice it is found that, despite the good adhesion of polyurethane to other materials, the adhesion of elastic polyurethane moldings on untreated rubber soles is not sufficient. The rubber sole used is therefore chemically modified or, respectively, provided with a layer composed of primer and adhesive, on the surface facing toward the polyurethane, in order to ensure adhesion to the polyurethane. Specifically for safety shoes, EN ISO 20 345 specifies that adhesion relating to peel of the layers has to be at least 4 N/mm. If this value relates to a foam crack it has to be at least 3 N/mm.

There are various known processes for improving adhesion between elastic polyurethane moldings and rubber. For example EP-A 286 966 discloses a process for production of “combisoles” by exposing the surface of an elastomeric material to plasma treatment in vacuo and then applying a polyurethane foam layer via application of a polyurethane reaction mixture.

“Surface treatment of vulcanized latex soles to improve their adhesion performance in shoe manufacturing”, J. Adh. Sci. Techn. 2005, 19 (1), 19-40 by C. M. Cepeda-Jiminez et al. describes the need for pretreatment of rubber via halogenation in order to achieve adhesion of polyurethane on rubber.

Disadvantages of these processes are that additional operations, and also additional cost for production time and capital expenditure on machinery are needed for production of a “combisole” with adequate adhesion between rubber and polyurethane.

It was therefore an object of the present invention to provide a composite material which is composed of rubber and of an elastic polyurethane molding with cellular core and with a compact surface, and which exhibits a high level of adhesion between rubber and polyurethane.

A further object was to provide a simpler, low-cost process which can produce this composite material and which needs no additional operations, and which needs no additional machinery.

These objects are achieved via a composite material according to claim 1, comprising an elastic polyurethane molding with compact surface and with cellular core and rubber, capable of production via introduction of a reaction mixture, obtainable via mixing of (a) organic polyisocyanates with (b) at least one compound having at least two reactive hydrogen atoms, (c) chain extenders and/or crosslinking agents, (d) blowing agents, (e) catalysts, (f) hyperbranched polymers, and (g) if appropriate, other auxiliaries and/or additives, into a mold, comprising rubber, and also via a process for production of a composite material, comprising an elastic polyurethane molding with compact surface and with cellular core and rubber, according to claim 18.

An inventive composite material here is a composite material in which the elastic polyurethane molding with cellular core and with compact surface is in direct contact with the rubber and has adhesive bonding thereto.

For the purposes of the invention, rubber is elastomers, e.g. butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), and natural rubber (NR), where these may be either pure or else present in blends with one another. The elastomers here comprise, if appropriate, commercially available fillers, such as carbon blacks, silica, chalk, metal oxides, plasticizers, antioxidants, antiozonants, and/or thermoplastic polymers, such as thermoplastics comprising styrene, examples being polystyrene or polystyrene-acrylonitrile (SAN), ethylene-vinyl acetate (EVA), polyethylene, polypropylene, polycarbonate, thermoplastic polyurethane (TPU), polyvinyl chloride (PVC), or thermoplastic elastomers based on styrene-butadiene-styrene block copolymers or on styrene-isoprene-styrene block copolymers, or blends composed of the thermoplastics mentioned with one another.

The rubber used preferably comprises vulcanized rubber mixtures. Vulcanized rubber here is the pure elastomers or elastomer blends, or elastomers or elastomer blends comprising fillers, in particular thermoplastic polymers, these having been vulcanized with vulcanization accelerators and/or crosslinking agents based on sulfur or based on peroxide, in accordance with familiar practice. Examples of these vulcanized rubber mixtures are described in P. A. Ciullo, “The rubber formulary”, Hoyes Publications, 1999, ISBN: 0-8155-1434-4. Vulcanized rubber is particularly preferably rubber comprising butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), and natural rubber (NR), or a mixture thereof, and has been mixed with vulcanization accelerators and/or crosslinking agents based on sulfur or on peroxide, in accordance with familiar practice. In particular, the rubber used comprises vulcanized acrylonitrile-butadiene rubber or styrene-butadiene rubber.

Polyurethane moldings with cellular core and with compact surface are polyurethane foams to DIN 7726 with a marginal zone whose density is higher than that of the core as a consequence of the shaping process. The overall envelope density here averaged over the core and the marginal zone is preferably above 0.10 g/cm³, particularly preferably from 0.15 to 0.75 g/cm³, and in particular from 0.25 to 0.70 g/cm³.

The inventive moldings are produced here by mixing (a) organic polyisocyanates with (b) at least one compound having at least two reactive hydrogen atoms, (c) chain extenders and/or crosslinking agents, (d) blowing agents, (e) catalysts, (f) hyperbranched polymers, and (g) if appropriate, other auxiliaries and/or additives, and placing them in a mold comprising rubber.

The organic and/or modified polyisocyanates (a) used for production of the inventive polyurethane composites encompass the aliphatic, cycloaliphatic, and aromatic by- or polyfunctional isocyanates known from the prior art (constituent a-1), or else in desired mixture thereof. Examples are diphenylmethane 4,4′-diisocyanate, diphenylmethane 2,4′-diisocyanate, mixtures composed of monomeric diphenylmethane diisocyanates and of homologues of diphenylmethane diisocyanate having a higher number of aromatic rings (polymer MDI), tetramethylene diisocyanate, hexamethylene diisocyanate (HDI), isophorone diisocyanate (IPDI), tolylene 2,4- or 2,6-diisocyanate (TDI), or a mixture of the isocyanates mentioned.

It is preferable to use 4,4′-MDI. The 4,4′-MDI preferably used can comprise from 0 to 20% by weight of 2,4′ MDI and small amounts, up to about 10% by weight, of allophanate- or uretonimine-modified polyisocyanates. It is also possible to use small amounts of polyphenylene polymethylene polyisocyanate (polymer MDI). The total amount of these high-functionality polyisocyanates should not exceed 5% by weight of the isocyanate used.

The polyisocyanate component (a) is preferably used in the form of polyisocyanate prepolymers. These polyisocyanate prepolymers are obtainable by reacting polyisocyanates (a-1) described above, for example at temperatures of from 30 to 100° C., preferably at about 80° C., with polyols (a-2), to give the prepolymer. To produce the inventive prepolymers it is preferable to use 4,4′-MDI together with uretonimine-modified MDI and commercially available polyols based on polyesters, for example starting from adipic acid, or on polyethers, for example starting from ethylene oxide and/or propylene oxide.

Polyols (a-2) are known to the person skilled in the art and are described by way of example in “Kunststoffhandbuch, Band 7, Polyurethane” [Plastics handbook, volume 7, Polyurethanes], Carl Hanser Verlag, 3rd edition 1993, Chapter 3.1.

Prepolymers based on ether are preferably obtained via reaction of polyisocyanates (a-1), particularly preferably 4,4′-MDI, with di- to trihydric polyoxypropylene polyols and/or polyoxypropylene-polyoxyethylene polyols. They are mostly produced via the well-known basic-catalyzed addition reaction of propylene oxide alone or in a mixture with ethylene oxide onto H-functional, in particular OH-functional, starter substances. Examples of starter substances used are water, ethylene glycol or propylene glycol, or glycerol or trimethylolpropane. Other catalysts that can be used are multimetal cyanide compounds, known as DMC catalysts. By way of example, polyethers as described below under (b) can be used as component (a-2).

If ethylene oxide/propylene oxide mixtures are used, it is preferable to use from 10-50% by weight of ethylene oxide, based on the total amount of alkylene oxide. The alkylene oxides here can be incorporated in the form of blocks or as a random mixture. It is particularly preferable to incorporate an ethylene oxide end block (“EO cap”), in order to increase the content of relatively reactive primary OH end groups. The number-average molar mass of the polyols (a-2) is preferably from 1750 to 4500 g/mol.

Conventional chain extenders or crosslinking agents are, if appropriate, added to the polyols mentioned during the production of the isocyanate prepolymers. These substances are described below under c). Chain extenders or crosslinking agents used particularly preferably comprise dipropylene glycol or tripropylene glycol.

Examples of relative high-molecular-weight compounds b) having at least two H atoms reactive toward isocyanate groups are polyetherols or polyesterols.

Polyetherols are prepared by known processes, for example via anionic polymerization using, as catalysts, alkali metal hydroxides or alkali metal alcoholates, and with addition of at least one starter molecule which comprises from 2 to 3 reactive hydrogen atoms, or via cationic polymerization using Lewis acids, such as antimony pentachloride or boron fluoride etherate, from one or more alkylene oxides having from 2 to 4 carbon atoms in the alkylene radical. Examples of suitable alkylene oxides are tetrahydrofuran, propylene 1,3-oxide, butylene 1,2-oxide, butylene 2,3-oxide, and preferably ethylene oxide and propylene 1,2-oxide. Other catalysts that can be used are multimetal cyanide compounds, known as DMC catalysts. The alkylene oxides can be used individually, in alternating succession, or in the form of a mixture. It is preferable to use mixtures composed of propylene 1,2-oxide and ethylene oxide, where the amounts of ethylene oxide used as ethylene oxide end block (EO cap) are from 10 to 50%, giving the resultant polyols more than 70% of primary OH end groups.

The starter molecule used can comprise water or di- and trihydric alcohols, such as ethylene glycol, 1,2- and 1,3-propanediol, diethylene glycol, dipropylene glycol, 1,4-butanediol, glycerol, or trimethylolpropane.

The functionality of the polyether polyols, preferably polyoxypropylene-polyoxyethylene polyols, is from 2 to 3 and their molar masses are from 1000 to 8000 g/mol, preferably from 2000 to 6000 g/mol.

By way of example, polyester polyols can be prepared from organic dicarboxylic acids having from 2 to 12 carbon atoms, preferably from aliphatic dicarboxylic acids having from 4 to 6 carbon atoms, and from polyhydric alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids here can be used either individually or else in a mixture with one another. Instead of the free dicarboxylic acids, it is also possible to use the corresponding dicarboxylic acid derivatives, e.g. dicarboxylic esters of alcohols having from 1 to 4 carbon atoms, or dicarboxylic anhydrides. It is preferable to use dicarboxylic acid mixtures composed of succinic, glutaric, and adipic acid in quantitative proportions of, for example, from 20 to 35: from 35 to 50: from 20 to 32 parts by weight, and in particular adipic acid. Examples of di- and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, and trimethylolpropane. It is preferable to use ethanediol, diethylene glycol, 1,4-butanediol, 1,5-pentanediol, and 1,6-hexanediol. It is also possible to use polyester polyols derived from lactones, e.g. ε-caprolactone, or hydroxycarboxylic acids, e.g. ω-hydroxycaproic acid.

For preparation of the polyester polyols, the organic, e.g. aromatic, and preferably aliphatic, polycarboxylic acids and/or their derivatives and polyhydric alcohols can be polycondensed without a catalyst or preferably in the presence of esterification catalysts, advantageously in an atmosphere composed of inert gas, e.g. nitrogen, carbon monoxide, helium, argon, etc., in the melt at temperatures of from 150 to 250° C., preferably from 180 to 220° C., if appropriate at subatmospheric pressure, until the desired acid number which is preferably smaller than 10, particularly preferably smaller than 2, has been reached. In one preferred embodiment, the esterification mixture is polycondensed at atmospheric pressure at the above-mentioned temperatures until an acid number of from 80 to 30, preferably from 40 to 30, has been reached, and then polycondensed at a pressure smaller than 500 mbar, preferably from 50 to 150 mbar. Examples of esterification catalysts that can be used are iron catalyst, cadmium catalyst, cobalt catalyst, lead catalyst, zinc catalyst, antimony catalyst, magnesium catalyst, titanium catalyst, and tin catalyst, in the form of metals, or of metal oxides, or of metal salts. However, the polycondensation reaction can also be carried out in the liquid phase in the presence of diluents and/or entrainers, e.g. benzene, toluene, xylene, or chlorobenzene, for azeotropic removal of the water of condensation by distillation. For the preparation of polyester polyols, the molar ratio of the organic polycarboxylic acids and/or their derivatives and polyhydric alcohols advantageously polycondensed is from 1 to 1:1.8, preferably 1: from 1.05 to 1.2.

It is preferable that the functionality of the resultant polyester polyols is from 2 to 4, in particular from 2 to 3, their molar mass being from 480 to 3000 g/mol, preferably from 1000 to 3000 g/mol.

The relatively high-molecular-weight compound b) used preferably comprises a mixture comprising polyetherols and polyesterols.

Other polyols suitable are polymer-modified polyols, preferably polymer-modified polyesterols or polyetherols, particularly preferably graft polyetherols or graft polyesterols, in particular graft polyetherols. These are what is known as a polymer polyol, usually having from 5 to 60% by weight, preferably from 10 to 55% by weight, particularly preferably from 30 to 55% by weight, and in particular from 40 to 50% by weight, content of preferably thermoplastic polymers. These polymer polyesterols are described by way of example in WO 05/098763 and EP-A 250 351, and are usually prepared via free-radical polymerization of suitable olefinic monomers, such as styrene, acrylonitrile, (meth)acrylates, (meth)acrylic acid, and/or acrylamide, in a polyesterol serving as graft base. The side chains are generally produced via transfer of the free radicals from growing polymer chains to polyesterols or polyetherols. The polymer polyol comprises, alongside the graft copolymer, mainly the homopolymers of the olefins, dispersed in unaltered polyesterol or polyetherol.

In one preferred embodiment, the monomers used comprise acrylonitrile, styrene, or acrylonitrile and styrene, particularly preferably exclusively styrene. The monomers are, if appropriate, polymerized in the presence of further monomers, of a macromer, and of a moderator, and with use of a free-radical initiator, mostly azo compounds or peroxide compounds, in a polyesterol or polyetherol as continuous phase. This process is described by way of example in DE 111 394, U.S. Pat. No. 3,304,273, U.S. Pat. No. 3,383,351, U.S. Pat. No. 3 523 093, DE 1 152 536, and DE 1 152 537.

During the free-radical polymerization reaction, the macromers are concomitantly incorporated into the copolymer chain. Block copolymers having a polyester block or polyether block and a polyacrylonitrile-styrene block are thus formed and act as compatibilizer at the interface between continuous phase and disperse phase and suppress agglomeration of the polymer polyesterol particles. The proportion of the macromers is usually from 1 to 20% by weight, based on the total weight of the monomers used for preparation of the polymer polyols.

If the relatively high-molecular-weight compound b) comprises polymer polyol, it is preferably present together with further polyols, e.g. polyetherols, polyesterols, or a mixture composed of polyetherols and of polyesterols. The proportion of polymer polyol is particularly preferably greater than 5% by weight, based on the total weight of component (b). Examples of the amount that can be present of the polymer polyols is from 7 to 90% by weight, or from 11 to 80% by weight, based on the total weight of component (b). The polymer polyol is particularly preferably polymer polyesterol or polymer polyetherol.

The chain extenders and/or crosslinking agents (c) used comprise substances whose molar mass is preferably smaller than 500 g/mol, particularly preferably from 60 to 400 g/mol; chain extenders here have 2 hydrogen atoms reactive toward isocyanates, and crosslinking agents have 3 hydrogen atoms reactive toward isocyanate. These can be used individually or preferably in the form of a mixture. It is preferable to use diols and/or triols whose molecular weights are smaller than 400, particularly preferably from 60 to 300, and in particular from 60 to 150. Examples of those that can be used are aliphatic, cycloaliphatic, and/or araliphatic diols having from 2 to 14, preferably from 2 to 10, carbon atoms, e.g. ethylene glycol, 1,3-propanediol, 1,10-decanediol, 1,2-, 1,3-, or 1,4-dihydroxycyclohexane, diethylene glycol, dipropylene glycol, and preferably 1,4-butanediol, 1,6-hexanediol, and bis(2-hydroxyethyl)hydroquinone, triols, such as 1,2,4- or 1,3,5-trihydroxycyclohexane, glycerol, and trimethylolpropane, and low-molecular-weight polyalkylene oxides which comprise hydroxy groups and are based on ethylene oxide and/or on propylene 1,2-oxide and the abovementioned diols and/or triols as starter molecules. Monoethylene glycol, 1,4-butanediol, and/or glycerol are particularly preferably used as chain extenders (c).

To the extent that chain extenders, crosslinking agents, or a mixture of these is used, their amounts advantageously used are from 1 to 60% by weight, preferably from 1.5 to 50% by weight, and in particular from 2 to 40% by weight, based on the weight of components (b) and (c).

Blowing agents (d) are also present during production of polyurethane foams. These blowing agents comprise, if appropriate, water (termed constituent (d-1)). Blowing agents (d) that can be used alongside water (d-1) are well-known compounds having chemical and/or physical reaction (the further chemical blowing agents here being termed constituent (d-2) and the physical blowing agents here being termed constituent (d-3)). Chemical blowing agents are compounds which via reaction with isocyanate form gaseous products, e.g. water or formic acid. Physical blowing agents are compounds which have been dissolved or emulsified in the starting materials for polyurethane production and evaporate under the conditions of polyurethane formation. Examples of these are hydrocarbons, halogenated hydrocarbons, and other compounds, e.g. perfluorinated alkanes, such as perfluorohexane, fluorochlorocarbons, and ethers, esters, ketones, and/or acetals, e.g. (cyclo)aliphatic hydrocarbons having from 4 to 8 carbon atoms, or fluorocarbons, e.g. Solkane® 365 mfc from Solvay Fluorides LLC. In one preferred embodiment, the blowing agent used comprises a mixture comprising at least one of these blowing agents and water, or in particular water only as blowing agent. If no water is used as blowing agent, it is preferable to use exclusively physical blowing agents.

In one preferred embodiment, the content of (d-1) water is from 0.1 to 2% by weight, preferably from 0.2 to 1.5% by weight, particularly preferably from 0.3 to 1.2% by weight, in particular from 0.4 to 1% by weight, based on the total weight of components (a) to (g).

In a further preferred embodiment, hollow microbeads which comprise physical blowing agent are added as additional blowing agent to the reaction of components (a), (b), and, if appropriate, (d). The hollow microbeads can also be used in a mixture with the abovementioned additional chemical blowing agents (d-2) and/or physical blowing agents (d-3).

The hollow microbeads are usually composed of a shell composed of thermoplastic polymer, having a core filled with a low-boiling-point liquid substance based on alkanes. The production of these hollow microbeads is described by way of example in U.S. Pat. No. 3,615,972. The diameter of the hollow microbeads is generally from 5 to 50 μm. Examples of suitable hollow microbeads are available with trademark Expancell® from Akzo Nobel.

The amount added of the hollow microbeads is generally from 0.5 to 5% by weight, based on the total weight of components (b), (d), and (d).

Catalysts (e) used for production of the polyurethane foams preferably comprise compounds which markedly accelerate the reaction of the compounds of component (b) and, if appropriate, (c), comprising hydroxy groups with the organic, if appropriate modified, polyisocyanates (a). Examples that may be mentioned are amidines, such as 2,3-dimethyl-3,4,5,6-tetrahydropyrimidine, tertiary amines, such as triethylamine, tributylamine, dimethylbenzylamine, N-methyl-, N-ethyl-, or N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. Organometallic compounds can also be used, preferably organotin compounds, such as stannous salts of organic carboxylic acids, e.g. stannous acetate, stannous octoate, stannous ethylhexoate, and stannous laurate, and the dialkyltin (IV) salts of organic carboxylic acids, e.g. dibutyltin diacetate, dibutyltin dilaurate, dibutyltin maleate, and dioctyltin diacetate, and also bismuth carboxylates, such as bismuth (III) neodecanoate, bismuth 2-ethylhexanoate, and bismuth octanoate, or a mixture thereof. The organometallic compounds can be used alone or preferably in combination with strongly basic amines. If component (b) is an ester, it is preferable to use exclusively amine catalysts.

It is preferable to use from 0.001 to 5% by weight, in particular from 0.05 to 2% by weight, of catalyst or catalyst combination, based on the weight of component (b).

For the purposes of the invention, hyperbranched polymers (f) are any of the polymers whose weight-average molar mass is greater than 500 g/mol and whose main chain has branching, and whose degree of branching (DB) is greater than or equal to 0.05. These are preferably hyperbranched polymers whose weight-average molar mass is greater than 800 g/mol, preferably greater than 1000 g/mol, and in particular greater than 1500 g/mol, and whose degree of branching is 0.1 or greater. The degree of branching of the inventive hyperbranched polymers is particularly preferably from 0.2 to 0.99 and in particular from 0.3 to 0.95, and very specifically from 0.35 to 0.75. For the definition of “degree of branching”, reference is made to H. Frey et al., Acta Polym. 1997, 48, 30.

Preferred hyperbranched polymers (f) are those based on ethers, on amines, on esters, on carbonates, on amides, on urethanes, and on ureas, and also mixed forms thereof, e.g. esteramides, amidoamines, ester carbonates, and urea urethanes. Hyperbranched polymers that can in particular be used are hyperbranched polyethers, polyesters, polyesteramides, polycarbonates, or polyester carbonates. These polymers and processes for their preparation are described in EP 1141083, in DE 102 11 664, in WO 00/56802, in WO 03/062306, in WO 96/19537, in WO 03/54204, in WO 03/93343, in WO 05/037893, in WO 04/020503, in DE 10 2004 026 904, in WO 99/16810, in WO 05/026234, and in DE 10 2005 009 166.

In one embodiment, the inventive hyperbranched polymers have various functional groups. These functional groups are preferably capable of reacting with isocyanates and/or with reactive groups of the rubber, or else of interacting with the rubber.

Examples of the functional groups which are reactive toward isocyanates are hydroxy groups, amino groups, mercapto groups, epoxy groups, carboxy groups, or anhydride groups, preferably hydroxy groups, amino groups, mercapto groups, or anhydride groups.

Examples of the functional groups which can react with the reactive groups of the rubber are groups capable of free-radical polymerization, e.g. olefinic double bonds, triple bonds, or activated double bonds, e.g. vinyl groups, (meth)acrylate groups, maleic acid groups or fumaric acid groups, or groups comprising derivatives thereof.

The functional groups which can interact with the rubber are units which do not react covalently with the solid but have interactions by way of positively or negatively charged groups, by way of electronic donor or acceptor bonding, by way of hydrogen bonds, by way of Van der Waals bonds, or by way of hydrophobic interactions.

Units generating hydrogen bonding or donor and acceptor bonding can, for example, be hydroxy groups, amino groups, mercapto groups, epoxy groups, carboxy groups, or anhydride groups, carbonyl groups, ether groups, olefinic double bonds, conjugated double bonds, triple bonds, activated double bonds, e.g. (meth)acrylate groups, or groups comprising maleic acid or comprising fumaric acid or comprising derivatives thereof.

Molecular domains generating Van der Waals bonds or hydrophobic interactions can, for example, be linear or branched alkyl, alkenyl, or alkynyl radicals whose chain length is from C₁ to C₁₂₀, or aromatic systems having from 1 to 10 ring systems, which may also have substitution by heteroatoms, such as nitrogen, phosphorus, oxygen, or sulfur. It is also possible to use linear or branched polyether molecular domains based on ethylene oxide, propylene oxide, butylene oxide, styrene oxide, or a mixture thereof, or else polyethers based on tetrahydrofuran or butanediol.

In one preferred embodiment, the inventive hyperbranched polymers (f) have not only groups reactive toward isocyanate but also groups which react with the rubber or interact with the rubber, for example the following structures obtained by way of the linking of the monomers cover ester structures, ether structures, amide structures, and/or carbonate structures, and also hydroxy groups, carboxy groups, amino groups, anhydride groups, (meth)acrylic double bonds, maleic double bonds, vinyl groups, and/or long-chain linear or branched alkyl radicals.

The inventive branched polymers (f) generally have an acid number of from 0 to 50 mg KOH/g, preferably from 1 to 35 mg KOH/g, and particularly preferably from 2 to 20 mg KOH/g, and in particular from 2 to 10 mg KOH/g, to DIN 53240, part 2.

The hyperbranched polymers (f) moreover generally have a hydroxy number of from 1 to 500 mg KOH/g, preferably from 10 to 500 mg KOH/g, and particularly preferably from 10 to 400 mg KOH/g, to DIN 53240, part 2.

The inventive hyperbranched polymers (f) generally moreover have a glass transition temperature (measured to ASTM method D3418-03 using DSC) of from −30 to 100° C., preferably from −20 to 80° C.

The inventive high-functionality, hyperbranched polymers f) are preferably amphiphilic polymers. The amphiphilic properties are preferably obtained via introduction of hydrophobic radicals into a hydrophilic, hyperbranched polymer, for example a hyperbranched polymer based on a polyester. These hydrophobic radicals preferably have more than 6, particularly preferably more than 8, and less than 100, and in particular more than 10, and less than 50, carbon atoms.

The hydrophobicization can be achieved during the esterification reaction by way of example via partial or complete replacement of di- and/or polycarboxylic acids or di- and/or polyols by mono-, di-, and/or polycarboxylic acids comprising an appropriate hydrophobic radical, or mono-, di-, and/or polyols comprising an appropriate hydrophobic radical. Examples of these mono-, di-, or polycarboxylic acids comprising a hydrophobic radical are aliphatic carboxylic acids, such as octanoic acid, decanoic acid, dodecanoic acid, tetradecanoic acid, fatty acids, such as stearic acid, oleic acid, lauric acid, palmitic acid, linoleic acid, linolenic acid, aromatic carboxylic acids, such as phthalic acid, isophthalic acid, terephthalic acid, trimellitic acid, cycloaliphatic carboxylic acids, such as cyclohexanedicarboxylic acid, dicarboxylic acids, such as octanedioic acid, decanedioic acid, dodecanedioic acid, tetradecanedioic acid, and dimeric fatty acids. Examples of mono-, di-, or polyols comprising a hydrophobic radical are aliphatic alcohols, such as the isomers of octanol, of decanol, of dodecanol, of tetradecanol, fatty alcohols, such as stearyl alcohol, oleyl alcohol, unsaturated alcohols, such as allyl alcohol, crotyl alcohol, aromatic alcohols, such as benzyl alcohol, cyloaliphatic alcohols, such as cyclohexanol and also fatty acid monoglycerides, e.g. glycerol monostearate, glycerol monooleate, glycerol monopalmitate.

The hyperbranched polymers f) generally have HLB value of from 1 to 20, preferably from 3 to 20, and particularly preferably from 4 to 20. If alkoxylated alcohols are used in the structure of the inventive high-functionality, highly branched and hyperbranched polymers, the HLB value is preferably from 5 to 8.

The HLB value is a measure of the hydrophilic and lipophilic content of a chemical compound. Determination of the HLB value is explained by way of example in W. C Griffin, Journal of the Society of Cosmetic Chemists, 1949, 1, 311 and W. C Griffin, Journal of the Society of Cosmetic Chemists, 1954, 5, 249.

For polyesters and hydrophobicized polyesters, the HLB value gives the ratio of the number of ethylene oxide groups multiplied by 100 to the number of carbon atoms in the lipophilic moiety of the molecule, and is calculated as follows by the method of C. D. Moore, M. Bell, SPC Soap, Perfum. Cosmet. 1956, 29, 893:

HLB=(number of ethylene oxide groups)*100/(number of carbon atoms in lipophilic moiety of molecule)

In one particularly preferred embodiment, the hyperbranched polymer (f) used comprises a hyperbranched polyester f1), which is obtained via esterification of α,β-unsaturated carboxylic acids or their derivatives with a polyhydric alcohol to give the polyester. Examples of α,β-unsaturated carboxylic acids or their derivatives used are preferably dicarboxylic acids or their derivatives, and in one particularly preferred embodiment here the double bond is adjacent to each of the two carboxy groups. Examples of these particularly preferred α,β-unsaturated carboxylic acids or their derivatives are maleic anhydride, maleoyl chloride, fumaroyl chloride, fumaric acid, itaconic acid, itaconoyl chloride, and/or maleic acid, preferably maleic acid, maleic anhydride, or maleoyl chloride, particularly preferably maleic anhydride. α,β-unsaturated carboxylic acids or their derivatives here can be used alone, in the form of a mixture with one another, or together with further carboxylic acids, preferably with di- or polycarboxylic acids, or with their derivatives, particularly preferably with dicarboxylic acids or with their derivatives, e.g. adipic acid. The expression “α,β-unsaturated carboxylic acids or their derivatives” below includes mixtures comprising two or more α,β-unsaturated carboxylic acids and mixtures comprising one or more α,β-unsaturated carboxylic acids and further carboxylic acids.

Polyesters f1) based on maleic anhydride are described by way of example in DE 10 2004 026 904, WO 2005/037893. The polyhydric alcohol used preferably comprises a polyetherol or polyesterol, for example as described under (b), or a mixture of various polyols. The average functionality of the entire mixture of the alcohols used here is from 2.1 to 10, preferably from 2.2 to 8, and particularly preferably from 2.2 to 4.

In the reaction of the α,β-unsaturated carboxylic acids or their derivatives with the polyhydric alcohol, the ratio of the reactive partners in the reaction is preferably selected in such a way as to comply with a molar ratio of molecules having groups reactive toward acid groups or toward their derivatives to molecules having acid groups or their derivatives of from 2:1 to 1:2, particularly preferably from 1.5:1 to 1:2, very particularly preferably from 0.9:1 to 1:1.5, and in particular 1:1. The reaction here is carried out under reaction conditions under which acid groups or their derivatives and groups reactive toward acid groups or toward their derivatives react with one another.

The particularly preferred hyperbranched polyesters are prepared via reaction of the α,β-unsaturated carboxylic acids or their derivatives with the polyhydric alcohol preferably at temperatures of from 80 to 200° C., particularly preferably of from 100 to 180° C. The preparation of the particularly preferred hyperbranched polyesters here can take place in bulk or in solution. Examples of suitable solvents are hydrocarbons, such as paraffins or aromatics. Particularly suitable paraffins are n-heptane, cyclohexane, and methylcyclohexane. Particularly suitable aromatics are toluene, ortho-xylene, meta-xylene, para-xylene, xylene in the form of isomer mixture, ethylbenzene, chlorobenzene, and ortho- and meta-dichlorobenzene. Other suitable solvents are ethers, such as dioxane or tetrahydrofuran, and ketones, such as methyl ethyl ketone and methyl isobutyl ketone.

The pressure conditions during the preparation of the particularly preferred polyesters f1) via reaction of α,β-unsaturated carboxylic acids or their derivatives with the polyhydric alcohol are per se non-critical. It is possible to operate at markedly subatmospheric pressure, for example at from 1 to 500 mbar. Their preparation process can also be carried out at pressures above 500 mbar. It is also possible to carry out the reaction at atmospheric pressure, and a reaction at slightly superatmospheric pressure, for example up to 1200 mbar, is also possible. It is also possible to operate at markedly superatmospheric pressure, for example at pressures of up to 10 bar. For reasons of simplicity, preference is given to the reaction at atmospheric pressure. The reaction at subatmospheric pressures is likewise preferred. The reaction time is usually from 10 minutes to 48 hours, preferably from 30 minutes to 24 hours, and particularly preferably from 1 to 12 hours.

The resultant particularly preferred hyperbranched polyesters f1) have a weight-average molar mass of from 1000 to 500 000, preferably from 2000 to 200 000, particularly preferably from 3000 to 120 000 g/mol, determined by means of PMMA-calibrated GPC.

In another particularly preferred embodiment, the hyperbranched polymer used comprises a hydrophobicized hyperbranched polyester f2). The procedure here for preparation of the hydrophobicized hyperbranched polyester f2) is analogous to that for preparation of the hyperbranched polyester f1), but all of, or some of, the α,β-unsaturated carboxylic acids or their derivatives used have been hydrophobicized. This hydrophobicization can take place after, or preferably prior to, the reaction with the alcohol to give the polyester. Hydrophobicizing agents that can be used preferably comprise hydrophobic compounds comprising at least one carbon-carbon double bond, e.g. linear or branched polyisobutylene, polybutadiene, polyisoprene, and unsaturated fatty acids or their derivatives. The reaction with the hydrophobicizing agents here takes place by processes known to the person skilled in the art, using an addition reaction of the hydrophobicizing agent onto the double bond in the vicinity of the carboxy group, as described by way of example in the German Laid-Open specifications DE 195 19 042 and DE 43 19 671. Particularly preferred hydrophobicized hyperbranched polyesters f2) of this type and their preparation are described by way of example in the prior application with file reference DE 10 2005 060 783.7. It is preferable here to start from polyisobutylene whose molar mass is from 100 to 10 000 g/mol, particularly preferably from 500 to 5000 g/mol, and in particular from 550 to 2000 g/mol.

In another particularly preferred embodiment, the hyperbranched polymer (f) used comprises a mixture comprising a hyperbranched polyester f1) and a hydrophobicized hyperbranched polyester f2).

If the component (b) used for production of the inventive composite material comprises more than 50% by weight, based on the total weight of component (b), of a polyesterol, the content of hyperbranched polyester f1) is preferably greater than 5% by weight, particularly preferably greater than 20% by weight, very particularly preferably greater than 50% by weight, and in particular 100% by weight, based on the total weight of the hyperbranched polymer (f).

If the component (b) used for production of the inventive composite material comprises more than 50% by weight, based on the total weight of component (b), of a polyetherol, the content of hyperbranched polyester f2) is preferably greater than 10% by weight, particularly preferably greater than 30% by weight, very particularly preferably greater than 60% by weight, and in particular 100% by weight, based on the total weight of the hyperbranched polymer (f).

The polyurethane preferably comprises an amount of from 0.001 to 50% by weight, particularly preferably from 0.01 to 30% by weight, and in particular from 0.1 to 10% by weight, based on the total weight of components (a) to (g), of the inventive hyperbranched polymers (f). It is possible here either to react the hyperbranched polymer with isocyanate for production of isocyanate prepolymers prior to production of the polyurethane molding or to delay contact between the hyperbranched polymer and isocyanate until production of the polyurethane molding takes place.

It is also possible, if appropriate, to add auxiliaries and/or additives (g) to the reaction mixture for production of the polyurethane foams. Examples that may be mentioned are surfactants, foam stabilizers, cell regulators, release agents, rubber-vulcanization auxiliaries, fillers, dyes, pigments, hydrolysis stabilizers, odor absorbents, and substances having fungistatic and/or bacteriostatic action.

Examples of surfactants that can be used are compounds which serve to promote the homogenization of the starting materials and, if appropriate, are also suitable for regulating the cell structure. Examples that may be mentioned are emulsifiers, such as the sodium salts of castor oil sulfates or of fatty acids, and also salts of fatty acids with amines, e.g. diethylamine oleate, diethanolamine stearate, diethanolamine ricinolate, salts of sulfonic acids, e.g. the alkali metal or ammonium salts of dodecylbenzene- or dinaphthylmethanedisulfonic acid, and ricinoleic acid; foam stabilizers, such as siloxane-oxalkylene copolymers and other organopolysiloxanes, ethoxylated alkylphenols, ethoxylated fatty alcohols, paraffin oils, castor oil esters or ricinoleic esters, Turkey red oil, and peanut oil, and cell regulators, such as paraffins, fatty alcohols, and dimethylpolysiloxanes. For improvement of emulsifying action, or the cell structure, and/or stabilization of the foam, other suitable substances are oligomeric acrylates having polyoxyalkylene and fluoroalkane radicals as side groups. The amounts usually used of the surfactants are from 0.01 to 5 parts by weight, based on 100 parts by weight of component (b).

Examples that may be mentioned of suitable release agents are: reaction products of fatty esters with polyisocyanates, salts derived from polysiloxanes comprising amino groups and fatty acids, salts derived from saturated or unsaturated (cyclo)aliphatic carboxylic acids having at least 8 carbon atoms and tertiary amines, and also in particular internal lubricants, e.g. carboxylic esters and/or carboxamides, prepared via esterification of amidation of a mixture composed of montanic acid and of at least one aliphatic carboxylic acid having at least 10 carbon atoms with at least dibasic alkanolamines, polyols, and/or polyamines whose molar masses are from 60 to 400 g/mol, as disclosed by way of example in EP 153 639, or with a mixture composed of organic amines, metal stearates, and organic mono- and/or dicarboxylic acids or their anhydrides, as disclosed by way of example in DE-A 36 07 447, or a mixture composed of an imino compound, of a metal carboxylate and, if appropriate, of carboxylic acid, as disclosed by way of example in U.S. Pat. No. 4,764,537.

Rubber vulcanization auxiliaries are the conventional crosslinking auxiliaries known per se for the vulcanization of rubber. Individual substances that may be mentioned by way of example are: vulcanizing agents, such as sulfur, peroxides, metal oxides, activators, such as metal oxides, e.g. the combination of zinc oxide and stearic acid, accelerators, such as thiurams, guanidines, thiazoles, sulfenamides, and dithiocarbamates. These are described by way of example in P. A. Ciullo, “The rubber formulary”, Hoyes Publications, 1999, ISBN: 0-8155-1434-4.

Fillers, in particular reinforcing fillers, are the conventional organic and inorganic fillers, reinforcing agents, weighting agents, coating compositions, etc. known per se. Individual substances that may be mentioned by way of example are: inorganic fillers, such as silicatic minerals, e.g. phyllosilicates, such as antigorite, bentonite, serpentine, hornblendes, amphiboles, chrysotile, and talc, metal oxides, such as kaolin, aluminum oxides, titanium oxides, zinc oxides, and iron oxides, metal salts, such as chalk and baryte, and inorganic pigments, such as cadmium sulfide, zinc sulfide, and also glass, etc. It is preferable to use kaolin (China clay), aluminum silicate, and coprecipitates composed of barium sulfate and aluminum silicate, or else natural or synthetic fibrous minerals, such as wollastonite, metal fibers of various lengths, and in particular glass fibers of various lengths, which may, if appropriate, have been sized. Examples of organic fillers that can be used are: carbon black, melamine, collophony, cyclopentadienyl resins, and graft polymers, and also cellulose fibers, polyamide fibers, polyacrylonitrile fibers, polyurethane fibers, polyester fibers based on aromatic and/or aliphatic dicarboxylic esters, and in particular carbon fibers.

The inorganic and organic fillers can be used individually or in the form of a mixture, their amounts advantageously added to the reaction mixture being from 0.5 to 50% by weight, preferably from 1 to 40% by weight, based on the weight of components (a) to (c), although the content of mats, nonwovens, and wovens composed or natural or synthetic fibers can reach values of up to 80% by weight here.

For production of an inventive composite material, the amounts of components (a) to (g) mixed with one another are such that the equivalence ratio of NCO groups of the polyisocyanate (a) to the entirety of the reactive hydrogen atoms of components (b), (c), (d), and (f) is from 1:0.8 to 1:1.25, preferably from 1:0.9 to 1:1.15. For the purposes of the invention, the mixture of components (a) to (g) is termed reaction mixture when reaction conversions are smaller than 90%, based on the isocyanate groups.

The inventive composite materials are preferably produced by the one-shot process with the aid of low-pressure or high-pressure technology, in closed, advantageously temperature-controlled, molds, comprising rubber. The molds are usually composed of metal, e.g. aluminum or steel. These procedures are described by way of example by Piechota and Röhr in “Integralschaumstoff” [Integral foam], Carl-Hanser-Verlag, Munich, Vienna, 1975, or in “Kunststoffhandbuch” [Plastics handbook], volume 7, Polyurethane [Polyurethanes], 3rd edition, 1993, chapter 7. The rubber here can be used without any pretreatment. The vulcanized rubber is preferably merely, for example, cleaned via wiping with ethanol. For further improvement of the adhesion, the rubber can also be pretreated via known processes, such as halogenation or plasma treatment.

The starting components (a) to (g) required for the process are preferably mixed at a temperature of from 15 to 90° C., particularly preferably from 25 to 55° C., and the reaction mixture is introduced, if appropriate at elevated pressure, into the closed mold. The mixing can be carried out mechanically by means of a stirrer or mixing screw, or at high pressure in what is known as the countercurrent injection process. The mold temperature is advantageously from 20 to 160° C., preferably from 30 to 120° C., particularly preferably from 30 to 60° C., but the rubber temperature can also be higher. The ratio by weight of components (a) to (g) to the rubber here is preferably from 1:0.01 to 1:10, particularly preferably from 1:0.1 to 1:2.

The amount of the reaction mixture introduced into the mold is judged so as to give the resultant molding composed of integral foams a density of from 0.08 to 0.70 g/cm³, in particular from 0.12 to 0.60 g/cm³. The degrees of compaction for production of the moldings with compacted marginal zone and cellular core are in the range from 1.1 to 8.5, preferably from 2.1 to 7.0.

An inventive composite material is preferably used as shoe sole. The inventive composite material here can be fastened after its production to the shoe upper, for example via sowing or adhesive bonding. As an alternative, an inventive shoe is produced by means of a direct injection process. Here, the reactive polyurethane mixture is placed in a mold which comprises an outer sole composed of rubber and which is sealed by the shoe upper.

Inventive composite materials have a good level of adhesion between the elastic polyurethane molding and rubber. The tensile bond strength here after 24 hours of storage at room temperature to EN ISO 20 344 is at least 4.0 N/mm, particularly preferably at least 4.5 N/mm, and in particular at least 5.0 N/mm for peeling of the layers, and preferably at least 3.0 N/mm, particularly preferably at least 3.5 N/mm, and in particular at least 4.0 N/mm, for a foam crack.

With this, advantages of an inventive composite material are improved adhesion between polyurethane molding and rubber. This can be achieved without use of additional steps and/or of complicated processes which improve adhesion but are aggressive or are hazardous to health.

The invention is illustrated below by examples.

### PREPARATION OF HYPERBRANCHED POLYMERS

### Example 1

### Synthesis of a Hyperbranched Polyester Comprising Hydroxy Groups, Carboxy Groups, Polyether Groups, and Branched Alkyl Radicals as Functional Molecular Domains

1925 g of an adduct derived from polyisobutylene whose molar mass is about 550 g/mol and maleic anhydride (PIBSA 550), 2354 g of a polyetherol based on trimethylolpropane which has been grafted randomly with 12 ethylene oxide units, and 0.5 g of dibutyltin dilaurate were weighed into a 4 l-glass flask equipped with stirrer, internal thermometer, and inclined condenser with vacuum connection, and heated slowly to 180° C. at a pressure of 40 mbar, with stirring, with some foaming due to the gas bubbles produced. The reaction mixture was stirred at 180° C. for 18 h, the water produced during the reaction being removed by distillation.

The fall-off of the acid number was regularly monitored until a value of about 6 mg KOH/g had been achieved. The product was then cooled and analyzed.

### Analysis:

Acid number: 5.5 mg KOH/g
OH number: 85 mg KOH/g
GPC: Mₙ=2300, M_{w}=12 900 (eluent: THF)

### Example 2

### Synthesis of a Hyperbranched Polyester Comprising Hydroxy Groups, Carboxy Groups, Polyether Groups, and Branched Alkyl Radicals as Functional Molecular Domains

300 g of an adduct derived from polyisobutylene whose molar mass is about 1000 g/mol and maleic anhydride (PIBSA 1000), 270 g of a polyetherol based on glycerol which has been grafted randomly with 18 ethylene oxide units, and 0.02 g of dibutyltin dilaurate were weighed into a 2 l-glass flask equipped with stirrer, internal thermometer, and inclined condenser with vacuum connection, and heated to 160° C. at a pressure of 4 mbar. Within about one hour, the temperature was slowly increased to 180° C. The water produced during the reaction was removed by distillation, with some foaming due to the gas bubbles produced.

The fall-off of the acid number was regularly monitored until a value of below 10 mg KOH/g had been achieved. The product was then cooled and analyzed.

### Analysis:

Acid number: 6.5 mg KOH/g
OH number: 44 mg KOH/g
GPC: Mₙ=2900, M_{w}=8600 (eluent: THF)

### Example 3

### Synthesis of a Hyperbranched Polyester Comprising Hydroxy Groups, Carboxy Groups, and Maleic Double Bonds as Functional Molecular Domains

574.7 g of trimethylolpropane, 420 g of maleic anhydride, 994.7 g of methylcyclohexane, and 0.2 g of dibutyltin dilaurate were weighed together into a flask equipped with stirrer, internal thermometer, and water separator, and were slowly heated at atmospheric pressure, with stirring. Reflux began at from 100-105° C., and water separated in the water separator. The reaction mixture was stirred at reflux for 23 hours, the amount of water separated being 51 g.

The mixture was then cooled to room temperature and the supernatant methylcyclohexane was decanted. 100 g of methanol were admixed with the residue, which was dissolved, with stirring and heating. The solution was then freed from solvent on a rotary evaporator at 90° C. and at a pressure of 20 mbar, and the moderately viscous residue was cooled to room temperature.

### Analysis:

Acid number: 77 mg KOH/g
OH number: 243 mg KOH/g

### T_{g}=9° C.

GPC Mn=2500, Mw=28 200 (eluent: DMAc)

### Example 4

### Synthesis of a Hyperbranched Polyester Comprising Hydroxy Groups, Carboxy Groups, and Maleic Double Bonds as Functional Molecular Domains

1149.4 g of trimethylolpropane, 420 g of maleic anhydride, 625.8 g of adipic acid, and 0.08 g of dibutyltin dilaurate were weighed together into a flask equipped with stirrer, internal thermometer, and inclined condenser with vacuum connection, and initially slowly heated at atmospheric pressure, without stirring, until the mixture melted at about 80° C. Then the mixture was heated to 140° C., with stirring. The reaction mixture was stirred at this temperature for 2 hours, the amount of water removed by distillation being 99 g.

The mixture was then cooled somewhat and a further 229.9 g of trimethylolpropane were added. The mixture was then again heated to 140° C. and the pressure was slowly lowered in stages to 50 mbar. The temperature was the increased to 160° C.

After 3 hours at 160° C. and at a pressure of 40 mbar, the acid number was about 30 mg KOH/g. The temperature was increased to 180° C. After a further 3.5 hours and after a final vacuum of 30 mbar had been reached, the acid number achieved was <10 mg KOH/g, and the reaction mixture was cooled.

### Analysis:

Acid number: 9 mg KOH/g
OH number: 331 mg KOH/g

### T_{g}=−15° C.

GPC Mn=3700, Mw=104 000 (eluent: DMAc)

### Example 5

### Synthesis of a Hyperbranched Polyester Comprising Hydroxy Groups, Carboxy Groups, Polyether Groups, Maleic Double Bonds, and Branched Alkyl Radicals as Functional Molecular Domains

1000 g of an adduct derived from polyisobutylene whose molar mass is about 1000 g/mol and maleic anhydride (PIBSA 1000), 1340 g of a polyetherol based on trimethylolpropane which has been grafted randomly with 12 ethylene oxide units, 98 g of maleic anhydride, and 0.4 g of dibutyltin dilaurate were weighed into a 4 l-glass flask equipped with stirrer, internal thermometer, and inclined condenser with vacuum connection, and heated to 180° C. at a pressure of 40 mbar. The reaction mixture was stirred at this temperature for 12 hours, the water produced during the reaction being removed by distillation.

The fall-off of the acid number was regularly monitored until a value of below 10 mg KOH/g had been achieved. The product was then cooled and analyzed.

### Analysis:

Acid number: 6.1 mg KOH/g
OH number: 102 mg KOH/g
GPC: Mₙ=1150, M_{w}=10 550 (eluent: THF)

### Example 6

### Synthesis of a Hyperbranched Polyester Comprising Hydroxy Groups, Carboxy Groups, and Linear Alkyl Radicals as Functional Molecular Domains

700 g of adipic acid, 374.9 g of glycerol, and 257.6 g of glycerol monostearate were used as initial charge in a 2 l glass flask equipped with stirrer, internal thermometer, gas inlet tube, and reflux condenser with vacuum connection and cold trap. The mixture was heated with the aid of an oil bath to an internal temperature of 150° C., 0.66 g of dibutyltin dilaurate was added and water of reaction produced was removed by distillation, the internal temperature being slowly raised to 180° C. Once 120 g of water had been removed by distillation, a reduced pressure of 80 mbar was applied and a further 39 g of water were removed by distillation. Cooling gave the hyperbranched polyester in the form of a viscous liquid.

GPC Mn=2150, Mw=32 000 (eluent: DMAc)

### Analysis of Inventive Products:

The polymers were analyzed by gel permeation chromatography using a refractometer as detector. Tetrahydrofuran (THF) or dimethylacetamide (DMAc) was used as mobile phase, and polymethyl methacrylate (PMMA) was used as standard for molecular weight determination.
Glass transition temperatures T_{g} were determined by means of differential scanning calorimetry (DSC), the second heating curve being evaluated.
Acid number and OH number were determined to DIN 53240, part 2.

### Production of Rubber/PU Foam Composites

The components with the constitution stated in the tables were mixed at room temperature by a stirrer (Vollrath stirrer, 1800 rpm, dissolver disk with diameter of 70 mm). Rubber specimens of dimension 30×100×2 mm were heated at a temperature of 110° C. for 15 min in an oven and then, using a double-sided adhesive tape, were fixed in the center of an aluminum mold of dimensions 200×200×10 mm, heated to 50° C. The surface temperature of the rubber at the juncture of foaming was 90° C. in all of the experiments. 250 g of the PU reaction mixture were placed in the mold, and the mold was closed. The composite was demolded after 4 min of hardening time. After storage for 24 h at room temperature rubber-PU foam test specimens of dimension 100×7×10 mm were cut out and were conditioned at 50% rel. humidity and room temperature for a further 48 h. Tensile bond strength was then determined by a method based on EN ISO 20 344, except that the width of the test specimen was 7 instead of 10 mm.

### Isocyanate Components

The isocyanate components used comprised the commercially available products Iso 500 or Iso 187/9 from Elastogran GmbH. The prepolymers were produced according to the prior art (see, for example, EP 897 402). Iso 500 is an isocyanate prepolymer based on MDI and polyetherol mixtures whose NCO content is 20.4%. Iso 187/9 is an isocyanate prepolymer based on MDI and polyesterols whose NCO content is 17.5%.

Polyol 1 is a polyetherol based on propylene oxide/ethylene oxide whose OH number is 29 and whose functionality, based on the starter, is 2. Polyol 2 is a polyetherol based on propylene oxide/ethylene oxide whose OH number is 27 and whose functionality, based on the starter, is 3. Polyol 3 is a polyesterol based on adipic acid and a mixture composed of monoethylene glycol and 1,4-butanediol whose OH number is 56 and whose functionality is 2. The cell regulator is a surfactant silicone polymer.

TABLE 1
Overview of constitution of Examples 7-12.

| | 7 | | | 10 | | |
|---|---|---|---|---|---|---|
| A component | (comp) | 8 | 9 | (comp) | 11 | 12 |
| Polyol 1 | 62.3 | 59.2 | 59.2 | 62.3 | 59.2 | 59.2 |
| Polyol 2 | 25.2 | 23.9 | 23.9 | 25.2 | 23.9 | 23.9 |
| 1,4-Butanediol | 9.5 | 9.1 | 9.1 | 9.5 | 9.1 | 9.1 |
| Monoethylene | 0.5 | 0.5 | 0.5 | 0.5 | 0.5 | 0.5 |
| glycol | | | | | | |
| Water | 0.3 | 0.3 | 0.3 | 0.3 | 0.3 | 0.3 |
| Lupragen | 1.4 | 1.3 | 1.3 | 1.4 | 1.3 | 1.3 |
| N 203 | | | | | | |
| Dabco BL 11 | 0.3 | 0.3 | 0.3 | 0.3 | 0.3 | 0.3 |
| Cell regulator | 0.4 | 0.4 | 0.4 | 0.4 | 0.4 | 0.4 |
| Polymer from | — | 5.0 | — | — | 5.0 | — |
| Ex. 1 | | | | | | |
| Polymer from | — | — | 5.0 | — | — | 5.0 |
| Ex. 5 | | | | | | |
| B component | Iso 500 | Iso 500 | Iso 500 | Iso 500 | Iso 500 | Iso 500 |
| MR: A:B | 100:70 | 100:67 | 100:67 | 100:70 | 100:67 | 100:67 |
| Rubber type | NBR 1 | NBR 1 | NBR 1 | NBR 2 | NBR 2 | NBR 2 |

(comp) = comparative example.
Quantitative data in parts by weight.

TABLE 2
Overview of constitution of Examples 13-16.

| A component | 13 (comp) | 14 | 15 (comp) | 16 |
|---|---|---|---|---|
| Polyol 3 | 88.7 | 85.1 | 59.2 | 59.2 |
| Chain extender 2 | 9.0 | 8.6 | 0.5 | 0.5 |
| Water | 0.4 | 0.4 | 0.3 | 0.3 |
| Amine catalyst 1 | 1.7 | 1.6 | 1.3 | 1.3 |
| Cell regulator | 0.2 | 0.2 | 0.2 | 0.2 |
| Polymer from Ex. 4 | — | 4.2 | — | — |
| Polymer from Ex. 3 | — | — | — | 4.2 |
| B component | Iso 187/9 | Iso 500 | Iso 500 | Iso 500 |
| MR: A:B | 100:110 | 100:106 | 100:110 | 100:106 |
| Rubber type | NBR 1 | NBR 1 | NBR 2 | NBR 2 |

(comp) = comparative example. Quantitative data in parts by weight.

TABLE 3
Overview of results of tensile bond strengths.

| | Tensile bond | Type of |
|---|---|---|
| Example | strength [N/mm] | fracture |
| 7 (comp) | 2.0-3.4 | A |
| 8 | 4.4 | B |
| 9 | 4.1 | B |
| 10 (comp) | 3.5 | A |
| 11 | 4.3 | B |
| 12 | 4.5 | B |
| 13 (comp) | 3.6 | A |
| 14 | 5.3 | B |
| 15 (comp) | 3.4 | A |
| 16 | 5.3 | B |

Types of fracture: a: separation between rubber and PU foam, b: separation with cracking in PU foam

The examples show that addition of the inventive hyperbranched additives significantly increases the tensile bond strength between the PU foam and the rubber. Furthermore, it can be seen that in all of the inventive examples the type of fracture changes. Whereas in the comparative experiments the polyurethane foam is observed to peel from the rubber at the interface between the two materials, in the experiments of the inventive examples cracking occurs in the foam layer. An improvement in adhesion properties is observed not only for polyesterol-based systems (see Examples 7-12) but also for polyetherol-based systems (see Examples 13-16). This shows that the effect observed is applicable to the entire range of available shoe foam systems, thus permitting compliance with the standards relating to adhesion properties in the shoe industry.

1. A composite material comprising an elastic polyurethane molding with a compact surface and a cellular core and rubber, capable of production via introduction of a reaction mixture, obtainable via mixing of
a) an organic polyisocyanate,
b) at least one relatively high-molecular-weight compound having at least two reactive hydrogen atoms,
c) a chain extender and/or a crosslinking agent,
d) a blowing agent,
e) a catalyst,
f) a hyperbranched polymer, and
g) if appropriate, other auxiliaries and/or additives, into a mold, comprising rubber.

2. The composite material according to claim 1, wherein the rubber used comprises a rubber based on butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), and natural rubber (NR), or a mixture thereof, and has been vulcanized with vulcanization accelerators and/or crosslinking agents based on sulfur or on peroxide.

3. The composite material according to claim 1, wherein the rubber comprises, as fillers, carbon black, silica, chalk, metal oxide, plasticizers, antioxidants, antiozonants, and/or thermoplastic polymers.

4. The composite material according to claim 1, wherein the molar mass of the hyperbranched polymer f) is greater than 500 g/mol and its degree of branching is greater than or equal to 0.05.

5. The composite material according to claim 1, wherein the hyperbranched polymer f) is a hyperbranched polymer based on ethers, on amines, on esters, on carbonates, on amides, on urethanes, or on ureas, and also mixed forms thereof.

6. The composite material according to claim 1, wherein the hyperbranched polymer f) comprises molecular domains generating hydrophobic interactions and/or comprises groups reactive toward free-radical polymerization.

7. The composite material according to claim 1, wherein the hyperbranched polymer f) has been incorporated via covalent bonding into the polymer matrix of the polyurethane.

8. The composite material according to claim 1, wherein the amount of the hyperbranched polymer f) present in the polyurethane is from 0.001 to 50% by weight, based on the total weight of the polyurethane.

9. The composite material according to claim 1, wherein the hyperbranched polymer f) is a hyperbranched polymer comprising hydrophobic units having more than 6 carbon atoms.

10. The composite material according to claim 9, wherein at least one of the hydrophobic units present comprises a fatty acid radical or a fatty alcohol radical.

11. The composite material according to claim 1, wherein the hyperbranched polymer f) is a hyperbranched polyester f1) which is obtained via esterification of an α,β-unsaturated carboxylic acid or its derivative with a polyhydric alcohol.

12. The composite material according to claim 1, wherein the hyperbranched polymer f) is a hyperbranched polyester f2) which is obtained via esterification of an α,β-unsaturated carboxylic acid or its derivative with a polyhydric alcohol, where the α,β-unsaturated carboxylic acid or its derivative is hydrophobicized with a hydrophobicizing agent comprising at least one carbon-carbon double bond, prior to or after the esterification reaction.

13. The composite material according to claim 11, wherein the hydrophobicizing agent is linear or branched polyisobutylene.

14. The composite material according to claim 1, wherein the at least one compound having at least two reactive hydrogen atoms (b) comprises at least 50% by weight, based on the total weight of component (b), of a polyesterol, and wherein the hyperbranched polymer (f) comprises at least 5% by weight, based on the total weight of component (f), of a hyperbranched polyester f1).

15. The composite material according to claim 1, wherein the at least one compound having at least two reactive hydrogen atoms (b) comprises at least 50% by weight, based on the total weight of component (b), of a polyetherol, and wherein the hyperbranched polymer (f) comprises at least 10% by weight, based on the total weight of component (f), of a hyperbranched polyester f2).

16. A shoe sole, comprising a composite material according to claim 1.

17. A composite material according to claim 1 as a shoe sole.

18. A process for production of a composite material, comprising an elastic polyurethane molding with a compact surface and with a cellular core and rubber, by mixing
a) an organic polyisocyanate,
b) at least one compound having at least two reactive hydrogen atoms,
c) a chain extender and/or a crosslinking agent,
d) a blowing agent,
e) a catalyst,
f) a hyperbranched polymer, and
g) if appropriate, other auxiliaries and/or additives, to give a reaction mixture and placing them in a mold which comprises rubber.

19. A hyperbranched polyesters as a constituent of a polyurethane molding with a cellular core and with a compact surface for improving adhesion between the polyurethane molding and rubber in a composite material.
